(19) United States
(12) Patent Application Publication
(10) Pub. No.: US 2025/0300897 A1
(43) Pub. Date: Sep. 25, 2025

(54) METHOD TO ENABLE USER EQUIPMENT APPARATUS DATA ANALYTICS IN A MOBILE COMMUNICATIONS NETWORK

(71) Applicant: Lenovo (Singapore) Pte. Limited, Singapore (SG)

(72) Inventors: Emmanouil Pateromichelakis, Viersen (DE); Dimitrios Karampatsis, Ruislip (GB)

(73) Assignee: Lenovo (Singapore) Pte. Limited, Singapore (SG)

(21) Appl. No.: 18/852,393

(22) PCT Filed: May 13, 2022
(86) PCT No.: PCT/EP2022/063093

§ 371 Date: Sep. 27, 2024

(30) Foreign Application Priority Data
Mar. 29, 2022 (GR) 20220100279

(51) Int. Cl. H04L 41/147; H04L 41/0833

(52) U.S. Cl. CPC H04L 41/147; H04L 41/0833

(57) ABSTRACT

There is provided a method for providing energy data analytics for a data network associated with a wireless communication system, the method comprising receiving at least one input parameter associated with energy usage corresponding to the data network, deriving energy data analytics for the data network based on the received at least one input parameter, and sending an energy data analytics output parameter based on the derived energy data analytics, wherein the energy data analytics output parameter comprises an energy usage statistic or energy usage prediction for the data network.

### FIELD

The present invention relates to energy data analytics performed at the network side or edge side of a mobile communications network, thereby to trigger actions to minimize energy usage or otherwise optimize network performance.

### BACKGROUND

Next generation mobile communication systems (5G-advanced, 6G) are expected to accommodate more demanding services, e.g. extended reality (XR), artificial intelligence (AI), and machine learning (ML), which will require much energy consumption at the device side as well as the network side. The impact on devices and the network of supporting these services will thus be huge and sometimes unpredictable.

An Energy Efficiency Metric requires first an understanding of an optimization target (end-to-end application service) and capturing one or more energy consumption contributor factors (depending on the involved User Equipment apparatuses, applications, and/or network nodes). There are different factors which contribute to the energy consumption for an application service (application service being defined in the present disclosure as a service between two or more applications, i.e. clients or servers, or both) which uses the 5G/6G system for its communication. Such contributing factors can be all processing and propagation needed for:
User plane data transfers (from the User Equipment apparatus to the Data Network) considering the transmission type, mode etc. (e.g., Uplink/Downlink/Side Link (SL), unicast/multicast/broadcast, or edge/cloud Data Network deployments).
Control plane services which are consumed by the application (e.g., which are exposable, or network-internal).
Management plane services which are consumed by the application (e.g., which are exposable, or Operations, Administration and Management system-internal).
Enablement layer (as defined in 3GPP SA6) services which are consumed by the application as value-added capabilities at the edge/cloud.
Computational resource usage at one or more edge telco clouds.

When deploying a communication service/slice to meet the application service requirements (e.g. gaming application requirements), the Mobile Network Operator needs to be aware of the expected energy consumption for its network and the impact on the devices. At the same time, the customer (e.g., the Application Service Provider or the edge cloud provider) needs to make sure that the application service doesn't consume significant energy for the end users, as well as for the data network side. Thus, some form of optimization is desirable, and this optimization requires the interaction between the edge cloud provider/Application Service Provider and Mobile Network Operator to ensure that the application service communication is energy-sustainable.

### SUMMARY

In an aspect, there is provided a method for providing energy data analytics for a data network associated with a wireless communication system, the method comprising receiving at least one input parameter associated with energy usage corresponding to the data network, deriving energy data analytics for the data network based on the received at least one input parameter, and sending an energy data analytics output parameter based on the derived energy data analytics, wherein the energy data analytics output parameter comprises an energy usage statistic or energy usage prediction for the data network.

In another aspect, there is provided a method for using energy data analytics for a data network of a wireless communication system, the method comprising receiving an energy data analytics output parameter, wherein the energy data analytics output parameter comprises an energy usage statistic or energy usage prediction for the data network, and performing a network action to reduce energy usage.

In yet another aspect, there is provided an apparatus comprising means for performing the method of any of the above aspects.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

FIG. 1 is a schematic illustration (not to scale) depicting two deployment models offering enablement and other services (based on 3GPP TS 23.558 Annex A2).

FIG. 2 is a schematic illustration (not to scale) of a network architecture related to a problem realized by the present inventors.

FIG. 3a is a schematic illustration (not to scale) of an on-network deployment of an enablement service.

FIG. 3b is a schematic illustration (not to scale) of an off-network deployment of an enablement service.

FIG. 4 is a schematic illustration (not to scale) of a user equipment apparatus that may be used for implementing the methods described herein.

FIG. 5 is a schematic illustration (not to scale) of a network node that may be used for implementing the methods described herein.

FIG. 6 is a schematic illustration (not to scale) of an architecture for implementing of a method for Application Server migration.

FIG. 7 is a schematic illustration (not to scale) of an implementation for deriving DN Energy Analytics based on load/resource usage.

FIG. 8 is a process flow chart showing certain steps of a method for providing energy data analytics for a data network of a wireless communication system.

FIG. 9 is a process flow chart showing certain steps of a further method for using energy data analytics for a data network of a wireless communication system.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatuses may be implemented as a hardware circuit comprising custom very-large-scale integration (“VLSI”) circuits or gate arrays, off-the-shelf semiconductors such as logic chips, transistors, or other discrete components. The disclosed methods and apparatuses may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, methods and apparatuses may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed methods and apparatuses are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding figures. Like numbers refer to like elements in all figures.

The present inventors have realized that a method of analyzing the energy efficiency for utilizing edge computational resources in order to make more sophisticated and holistic energy data analysis for a communication service is desirable. An energy efficiency level for the edge will be a crucial factor for applying energy-saving policies at the edge, which has limited resources. Such policies may include, for example, forcing the migration of application servers to different edges/clouds, or triggering application lifecycle changes or application service area changes, or scaling in-out, etc., to ensure that energy efficiency targets are met.

In edge scenarios, there may be different deployment models which may have edge-dedicated Data Networks (DNs) or non-edge dedicated DNs, or use of Local Area Data Networks (LADNs). For all cases, an Edge Data Network (EDN) can offer enablement and other services (e.g., network and application services) and use different Data Network Access Identifiers (DNAIs), which correspond to using different User Plane Functions (UPFs) for user plane data delivery. Moreover, it is possible that the edge computing services offered by different EDNs may have overlapping (partial or exact) coverage, and in some cases edge computing services are offered in local service areas (e.g., in the LADN scenario).

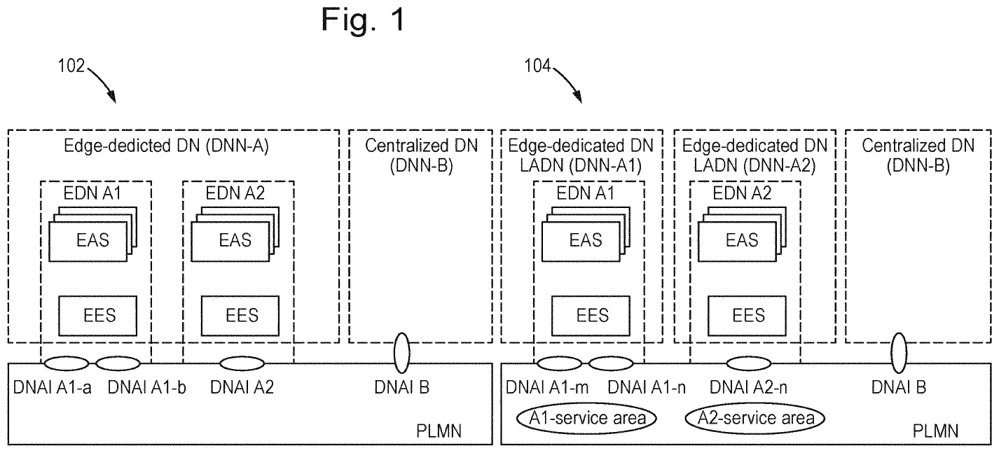

FIG. 1 depicts two such deployment models (based on 3GPP TS 23.558 Annex A2), in particular a first deployment model 102 and a second deployment model 104. In these models the PLMN supporting edge computing services provides connection to one or multiple DNs. The first deployment model 102 uses Edge-dedicated DNs for support of edge computing service. Each Edge-dedicated DN is configured with unique DNNs (Data Network Names). The PLMN supporting edge computing services provides connection to several EDNs that correspond to one or more DNAI(s), and each EDN is identified by DNN of the Edge-dedicated DN and one or more DNAI. In the second deployment model 104, edge computing services can be provided via Edge-dedicated Data Networks deployed as LADNs. With this option, the PLMN supports edge computing services in the EDN service areas which is equal to the LADN service area. The LADN service area is the service area that the Edge Computing is supported. Each individual EAS in the LADN can support the same or smaller service area than the LADN.

In this scenario, the energy consumption for EDNs 106 may be due to Edge Enabler Server (EES) 108 vCPU usage or Edge Application Server (EAS) 110 vCPU usage, Application Programming Interface (API) invocations (for edge services produced or consumed by the EDGE platform), and other energy consumptions, e.g. the Hardware (HW) or Network Functions Virtualization Infrastructure (NFVI) layer. Some of this consumption may be fixed; however, lots of the processing is analogous to the application services which require edge computing services for the communication of application traffic over 5GS. Therefore, by knowing the predicted/expected application service consumption and the predicted/expected impact to the edge platform for or over a given area and time, actions may be triggered to maintain a low energy consumption without sacrificing or undermining an agreed application service performance as determined by the corresponding Service-level Agreements (SLAs). Such capability is currently missing in the art, and the present invention aims to fill this gap and provide a value-added enablement, or Network Data Analytics Function (NWDAF), service for both the edge cloud provider and the ASP/MNO.

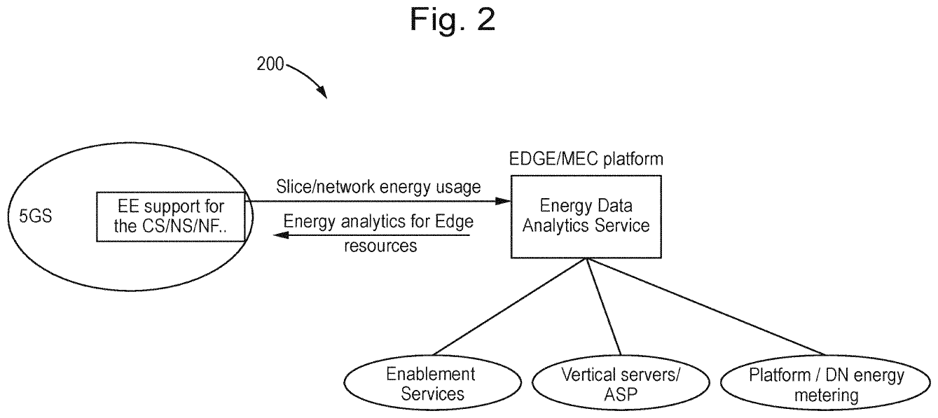

FIG. 2 is a schematic illustration of a network architecture related to a problem realized by the present inventors, depicting the scope of the solution with respect to 5GS and other domains. FIG. 2 illustrates an implementation 200 where the Energy Data Analytics Service resides at the mobile edge cloud (MEC or EDGE) and provides analytics to the 5G System, and in particular to the OAM or 5GC. OAM can provide data about energy usage for the managed elements (NSI, NF, CS etc.) and OAM has a corresponding service for measuring Energy Efficiency. EDAS by consuming this service, and by also acquiring energy and resource usage data from application layer side (edge/cloud and/or applications) it can provide analytics on the energy usage/efficiency and send this to the 5GS which can be seen in this example as possible consumer of such analytics.

In particular, problems to be solved include those of how to assure energy efficiency for DNs (edge or regional) or for DNAIs, while not sacrificing the application performance, and how to determine the energy to be consumed at a DN for supporting edge computing services for expected or predicted traffic usage and network load.

In 3GPP TS 22.261, it is disclosed that energy efficiency may be captured as a requirement mainly for the network side to allow an energy saving mode for the RAN side; but also provides requirements for the UE-side energy efficiency.

In particular, 3GPP TS 22.261 discloses that:
“Energy efficiency is a critical issue in 5G. The potential to deploy systems in areas without a reliable energy source requires new methods of managing energy consumption not only in the UEs but throughout all components of the 5G system. Small form factor UEs also typically have a small battery and this not only puts constrains on general power optimization but also on how the energy is consumed. With smaller batteries it is more important to understand and follow the limitations for the both the maximum peak and continuous current drain.
The 5G access network shall support an energy saving mode with the following characteristics: the energy saving mode can be activated/deactivated either manually or automatically; service can be restricted to a group of users (e.g. public safety user, emergency callers).
NOTE: When in energy saving mode the UE's and Access transmit power may be reduced or turned off (deep sleep mode), end-to-end latency and jitter may be increased with no impact on set of users or applications still allowed.

The 5G system shall support mechanisms to improve battery life for a UE over what is possible in EPS.
The 5G system shall optimize the battery consumption of a relay UE via which a UE is in indirect network connection mode.
The 5G system shall support UEs using small rechargeable and single coin cell batteries (e.g. considering impact on maximum pulse and continuous current).”

However, it is unclear whether the prediction of a service/UE demand can allow for more optimized actions by the 5GS with respect to energy saving. It is also unclear whether energy saving decisions need, or ought to have, coordination with, or input from, the end customer, and particularly the vertical customer, who usually does not expect service performance and availability degradation.

In 3GPP TR 28.813, the interaction between a NWDAF and a Management Data Analytics Service (MDAS) is discussed, as part of a key issue in clause 4.3. In this clause, a potential solution is described, wherein the 3GPP management system, and in particular the Management Data Analytics Function (MDAF), plays a central role during the observation phase, the analytics phase, and the decision phase (see TR 28.809 clause 5.1).

A Management Function (MF), principally responsible for energy saving, consumes analytics produced by the MDAF and thereafter takes appropriate decisions to save energy in the 5G core network.

The NWDAF sends to the MDAS UE communication analytics and OAM data related to a corresponding UPF or Session Management Function (SMF). The MDAS then derives UPF energy-saving analytics. Such analytics may relate to, or include, recommendations to Radio Access Network (RAN) nodes and UPFs to enter an energy-saving mode or to re-select UPF/RAN nodes to ensure low energy consumption.

The MDAS exposes such analytics to the MF in charge of energy saving for the network/slice.

The following table from TR 28.809 clause 6.6.1.3.3 shows potential information included within the analytics report of the MDAS, thereby to assist energy saving.

| | Attribute Name | Description |
|---|---|---|
| Analytics | Energy saving | The identifier of the MDA-assisted |
| Report of | analytics identifier | energy saving |
| MDA | Location | The geographical area, UPFs or the |
| assisted | | cells where the unreasonable energy |
| energy | | consumption exists or recommended |
| saving | | 5GC NF deployment options or NR |
| | | cells in high-value traffic geographical |
| | | area. |
| | Root cause | The root cause of the part of the |
| | | energy consumption that may be |
| | | conserved, e.g., ultra-low traffic load |
| | | area with energy consumption, |
| | | excessive energy consumption |
| | Trends of the traffic | Predictions related to the trends of |
| | load | traffic load(e.g. PRB utilization rate, |
| | | RRC connection number, etc.)which |
| | | could be used as references for |
| | | making decision on energy saving |
| | Recommended | The optimal prediction data models |
| | prediction data | which can be selected from the |
| | models | prediction data models (e.g. including |
| | | Model Id) to provide more accurate |
| | | information prediction results to |
| | | assist the energy saving related |
| | | decision making. |
| | Current Energy | The information of the current |
| | Saving State of the | energy saving state of the cells, e.g. |
| | cells | the cells which are currently in the |
| | | energy saving state. |
| | Energy saving | For ES on NR cells. It may contain a |
| | recommendations | set of |
| | | recommended NR Cell (ES- |
| | | Cell) to enter energySaving |
| | | state; |
| | | recommended candidate cells |
| | | with precedence for taking |
| | | over the traffic of the ES- |
| | | Cell; |
| | | a time period, during which |
| | | energy saving is or not |
| | | allowed; |
| | | predictions related to the |
| | | trends of traffic load which |
| | | could be used as references |
| | | for making decision on |
| | | energy saving of NR cells. |
| | | For ES on UPFs. It contains a set of |
| | | recommended UPF (ES- |
| | | UPF) to conduct energy |
| | | saving; |
| | | recommended candidate |
| | | UPFs with precedence for |
| | | taking over the traffic of the |
| | | ES-UPF; |
| | | a time period, during which |
| | | energy saving is or not |
| | | allowed; |
| | | predictions related to the trends of |
| | | traffic load which could be used as |
| | | references for making decision on |
| | | energy saving of UPFs. |

The MDAS exposes such analytics to the MF in charge of energy saving for the network/slice.

In the prior art, it is mentioned that energy analytics can be provided to predict trends of traffic load, which trends may be used as references for deciding energy-saving behaviours for UPFs. However, if we want to do the same for the edge platform, the following issues are relevant: how these trends can be used to save energy at the edge DN, and whether it is desirable/necessary to jointly optimize energy saving, considering both the network side and the edge computational resource factor.

3GPP SA6 is the application enablement and critical communications applications group for vertical markets. The main objective of SA6 is to provide application layer architecture specifications for 3GPP verticals, including architecture requirements and functional architecture for supporting the integration of verticals into 3GPP systems. With respect to application enablement, the main focus is on enablers for vertical applications (e.g. automotive applications) and service frameworks (e.g. Common API Framework, Service Enabler Architecture Layer, and Edge Application enablement).

Application Data Analytics Enablement Service (ADAES) (3GPP TR 23.700-36) describes a new enablement service which can be part of the Service Enabler Architecture Layer for Verticals (SEAL) and discusses new potential application data analytics services (stats/predictions) to optimize the application service operation by notifying the application specific layer, and potentially 5GS, of expected/predicted application service parameter changes, considering both on-network and off-network deployments, e.g. changes related to application Quality of Service (QOS) parameters.

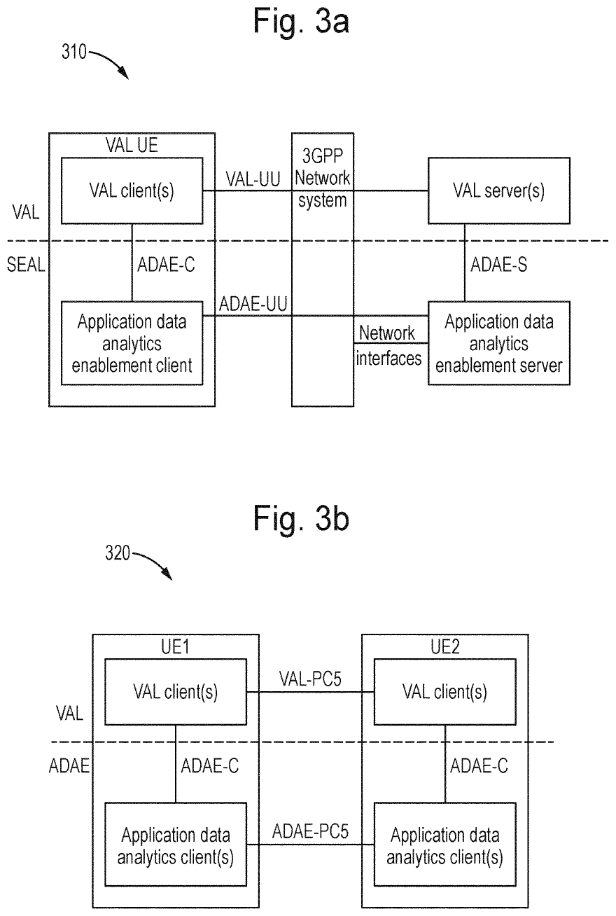

The on-network and off-network deployments, i.e. models, are shown in FIGS. 3a and 3b, which are schematic illustrations of, respectively, on-network and off-network ADAE models. FIGS. 3a/3b illustrate the overall functional architecture description, which includes the on-network and off-network functional models for ADAES (as discussed in TR 23.700-36). ADAES is an enablement service which can be within SEAL or EDGEAPP layer. The EDAS can be part of ADAES capability or a service co-located with ADAES.

FIG. 3a shows an architecture 310 in which the application data analytics enablement client communicates with the application data analytics enablement server over the ADAE-UU reference point. The application data analytics enablement client provides the support for application data analytics enablement functions to the VAL client(s) over ADAE C reference point. The VAL server(s) communicates with the application data analytics enablement server over the ADAE-S reference point. The application data analytics enablement server, acting as AF, may communicate with the 5G Core Network functions and OAM via network interfaces.

FIG. 3b shows an architecture 320 in which the VAL client of UE1 communicates with VAL client of UE2 over VAL-PC5 reference point. An application data analytics enablement client of UE1 interacts with the corresponding application data analytics enablement client of UE2 over ADAE-PC5 reference points. The UE1, if connected to the network via Uu reference point, can also act as a UE-to-network relay, to enable UE2 to access the VAL server(s) over the VAL-UU reference point.

With regards to energy-constrained devices (e.g. Internet of Things devices), application enablement covers, in the SEAL framework (TS 23.434), the use of the Light-weight Protocol (LWP) for constrained environments and in particularly the use of Constrained Application Protocol (CoAP, defined by IETF in RFC 7252) as a transport protocol for the communication between a SEAL server and SEAL clients. CoAP provides a request/response interaction model between application endpoints, supports built-in discovery of services and resources, and includes key concepts of the Web such as URIs and Internet media types. CoAP is designed to easily interface with HTTP for integration with the Web, while meeting specialized requirements such as multicast support, very low overheads, and simplicity for constrained environments.

The application enablement layer supports communication over LWP for constrained devices; however, it lacks support for defining an energy-constrained scenario and for providing specific enablement capabilities for supporting energy-constrained devices (e.g. via monitoring energy levels, etc.).

In 3GPP SA6, the EDGEAPP work specifies the application layer architecture for edge service. In this architecture 102/104, as outlined in 3GPP TS 23.558, the role of the entities depicted in FIG. 1 can be further defined.

The EES provides supporting functions needed for EEAs and an Edge Enabler Client (EEC), such as:
provisioning of configuration information to the EEC, enabling exchange of application data traffic with the EAS;
interacting with a 3GPP Core Network for accessing the capabilities of network functions (NFs) either directly, e.g. via a Plane Control Function (PCF) or indirectly, e.g. via a Service Capability Exposure Function (SCEF) or Network Exposure Function (NEF), or both; and
supporting external exposure of 3GPP network capabilities to the EAS(s) over EDGE-3.

The EEC provides supporting functions needed for Application Client(s), such as retrieval and provisioning of configuration information to enable the exchange of Application Data Traffic with the EAS, and discovery of an EAS(s) available in the EDN.

The ECS provides supporting functions needed for the EEC to connect with an EES. These functionalities of the ECS are related to the provisioning of edge configuration information to the EEC, which are used for establishing connection with the EES.

The EAS is the application server resident in the EDN and which performs the server functions.

The Application Client (AC) is the application resident in the UE and which performs the client function.

The solutions disclosed herein introduce a logical functionality at the DN side (at an edge platform or a cloud platform) to provide analytics on the DN energy consumption/efficiency. In a particular embodiment, for example, these analytics may be the edge platform expected/predicted energy consumption/efficiency. Such logical functionality, hereinafter denoted energy data analytics service (EDAS), may be a new NWDAF service or an enablement service which is part of ADAES/EES (defined in SA6), or part of a Multi-access Edge Computing system (MEC), e.g. as in a MEC service, or part of an OAM, e.g. as in a MDAS enhanced service.

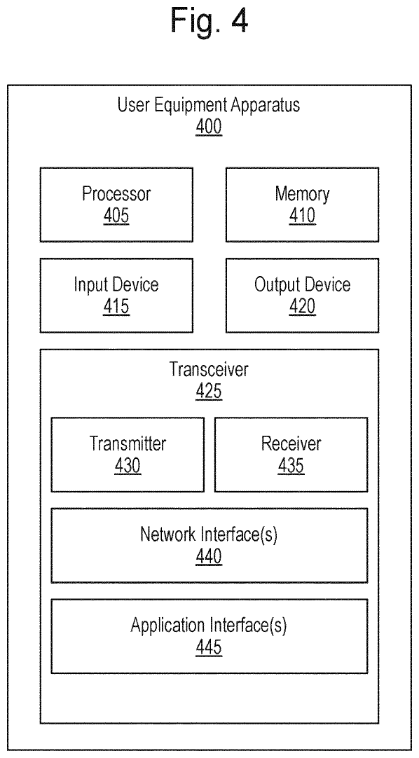

FIG. 4 depicts a user equipment apparatus (UE) 400 that may be used for implementing the methods described herein. The UE 400 is used to implement one or more of the solutions described below. The user equipment apparatus 400 includes a processor 405, a memory 410, an input device 415, an output device 420, and a transceiver 425.

The UE 400 is in accordance with the UEs described in other embodiments herein.

The input device 415 and the output device 420 may be combined into a single device, such as a touchscreen. In some implementations, the UE 400 does not include any input device 415 and/or output device 420. The UE 400 may include one or more of: the processor 405, the memory 410, and the transceiver 425, and may not include the input device 415 and/or the output device 420.

As depicted, the transceiver 425 includes at least one transmitter 430 and at least one receiver 435. The transceiver 425 may communicate with one or more cells (or wireless coverage areas) supported by one or more base units. The transceiver 425 may be operable on unlicensed spectrum. Moreover, the transceiver 425 may include multiple UE panels supporting one or more beams. Additionally, the transceiver 425 may support at least one network interface 440 and/or application interface 445. The application interface(s) 445 may support one or more APIs. The network interface(s) 440 may support 3GPP reference points, such as Uu, N1, PC5, etc. Other network interfaces 440 may be supported, as understood by one of ordinary skill in the art.

The processor 405 may include any known controller capable of executing computer-readable instructions and/or capable of performing logical operations. For example, the processor 405 may be a microcontroller, a microprocessor, a central processing unit (“CPU”), a graphics processing unit (“GPU”), an auxiliary processing unit, a field programmable gate array (“FPGA”), or similar programmable controller. The processor 405 may execute instructions stored in the memory 410 to perform the methods and routines described herein. The processor 405 is communicatively coupled to the memory 410, the input device 415, the output device 420, and the transceiver 425.

The processor 405 may control the UE 400 to implement the UE behaviors described herein. The processor 405 may include an application processor (also known as “main processor”) which manages application-domain and operating system (“OS”) functions and a baseband processor (also known as “baseband radio processor”) which manages radio functions.

The memory 410 may be a computer readable storage medium. The memory 410 may include volatile computer storage media. For example, the memory 410 may include a RAM, including dynamic RAM (“DRAM”), synchronous dynamic RAM (“SDRAM”), and/or static RAM (“SRAM”). The memory 410 may include non-volatile computer storage media. For example, the memory 410 may include a hard disk drive, a flash memory, or any other suitable non-volatile computer storage device. The memory 410 may include both volatile and non-volatile computer storage media.

The memory 410 may store data related to implementing a traffic category field. The memory 410 may also store program code and related data, such as an operating system or other controller algorithms operating on the UE 400.

The input device 415 may include any known computer input device including a touch panel, a button, a keyboard, a stylus, a microphone, or the like. The input device 415 may be integrated with the output device 420, for example, as a touchscreen or similar touch-sensitive display. The input device 415 may include a touchscreen such that text may be input using a virtual keyboard displayed on the touchscreen and/or by handwriting on the touchscreen. The input device 415 may include two or more different devices, such as a keyboard and a touch panel.

The output device 420 may be designed to output visual, audible, and/or haptic signals. The output device 420 may include an electronically controllable display or display device capable of outputting visual data to a user. For example, the output device 420 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 420 may include a wearable display separate from, but communicatively coupled to, the rest of the UE 400, such as a smart watch, smart glasses, a heads-up display, or the like. Further, the output device 420 may be a component of a smart phone, a personal digital assistant, a television, a table computer, a notebook (laptop) computer, a personal computer, a vehicle dashboard, or the like.

The output device 420 may include one or more speakers for producing sound. For example, the output device 420 may produce an audible alert or notification (e.g., a beep or chime). The output device 420 may include one or more haptic devices for producing vibrations, motion, or other haptic feedback. All, or portions, of the output device 420 may be integrated with the input device 415. For example, the input device 415 and output device 420 may form a touchscreen or similar touch-sensitive display. The output device 420 may be located near the input device 415.

The transceiver 425 communicates with one or more network functions of a mobile communication network via one or more access networks. The transceiver 425 operates under the control of the processor 405 to transmit messages, data, and other signals and also to receive messages, data, and other signals. For example, the processor 405 may selectively activate the transceiver 425 (or portions thereof) at particular times in order to send and receive messages.

The transceiver 425 includes at least one transmitter 430 and at least one receiver 435. The one or more transmitters 430 may be used to provide UL communication signals to a base unit of a wireless communications network. Similarly, the one or more receivers 435 may be used to receive DL communication signals from the base unit. Although only one transmitter 430 and one receiver 435 are illustrated, the UE 400 may have any suitable number of transmitters 430 and receivers 435. Further, the transmitter(s) 430 and the receiver(s) 435 may be any suitable type of transmitters and receivers. The transceiver 425 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 425, transmitters 430, and receivers 435 may be implemented as physically separate components that access a shared hardware resource and/or software resource, such as for example, the network interface 440.

One or more transmitters 430 and/or one or more receivers 435 may be implemented and/or integrated into a single hardware component, such as a multi-transceiver chip, a system-on-a-chip, an Application-Specific Integrated Circuit (“ASIC”), or other type of hardware component. One or more transmitters 430 and/or one or more receivers 435 may be implemented and/or integrated into a multi-chip module. Other components such as the network interface 440 or other hardware components/circuits may be integrated with any number of transmitters 430 and/or receivers 435 into a single chip. The transmitters 430 and receivers 435 may be logically configured as a transceiver 425 that uses one more common control signals or as modular transmitters 430 and receivers 435 implemented in the same hardware chip or in a multi-chip module.

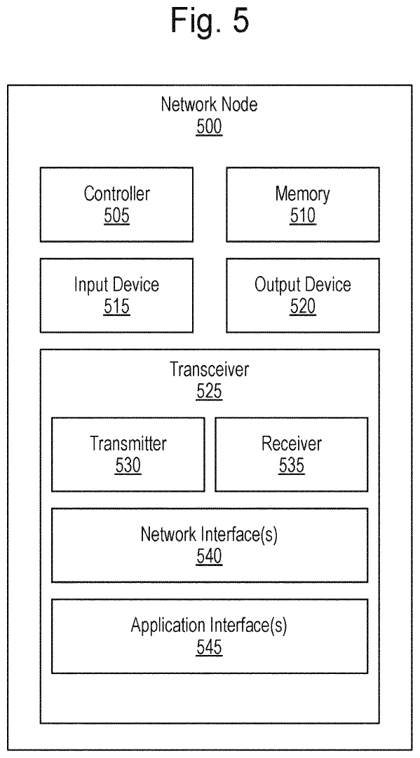

FIG. 5 depicts a network node 500 that may be used for implementing the methods described herein. The network node 500 may be one implementation of an entity in a wireless communications network, e.g. in one or more of the networks in embodiments described herein. The network node 500 may be, for example, the UE 400 described above. The network node 500 includes a controller 505, a memory 510, an input device 515, an output device 520, and a transceiver 525.

The input device 515 and the output device 520 may be combined into a single device, such as a touchscreen. In some implementations, the network node 500 does not include any input device 515 and/or output device 520. The network node 500 may include one or more of: the controller 505, the memory 510, and the transceiver 525, and may not include the input device 515 and/or the output device 520.

As depicted, the transceiver 525 includes at least one transmitter 530 and at least one receiver 535. Here, the transceiver 525 communicates with one or more remote units 500. Additionally, the transceiver 525 may support at least one network interface 540 and/or application interface 545. The application interface(s) 545 may support one or more APIs. The network interface(s) 540 may support 3GPP reference points, such as Uu, N1, N2 and N3. Other network interfaces 540 may be supported, as understood by one of ordinary skill in the art.

The controller 505 may include any known controller capable of executing computer-readable instructions and/or capable of performing logical operations. For example, the controller 505 may be a microcontroller, a microprocessor, a CPU, a GPU, an auxiliary processing unit, a FPGA, or similar programmable controller. The controller 505 may execute instructions stored in the memory 510 to perform the methods and routines described herein. The controller 505 is communicatively coupled to the memory 510, the input device 515, the output device 520, and the transceiver 525.

The memory 510 may be a computer readable storage medium. The memory 510 may include volatile computer storage media. For example, the memory 510 may include a RAM, including dynamic RAM (“DRAM”), synchronous dynamic RAM (“SDRAM”), and/or static RAM (“SRAM”). The memory 510 may include non-volatile computer storage media. For example, the memory 510 may include a hard disk drive, a flash memory, or any other suitable non-volatile computer storage device. The memory 510 may include both volatile and non-volatile computer storage media.

The memory 510 may store data related to establishing a multipath unicast link and/or mobile operation. For example, the memory 510 may store parameters, configurations, resource assignments, policies, and the like, as described below. The memory 510 may also store program code and related data, such as an operating system or other controller algorithms operating on the network node 500.

The input device 515 may include any known computer input device including a touch panel, a button, a keyboard, a stylus, a microphone, or the like. The input device 515 may be integrated with the output device 520, for example, as a touchscreen or similar touch-sensitive display. The input device 515 may include a touchscreen such that text may be input using a virtual keyboard displayed on the touchscreen and/or by handwriting on the touchscreen. The input device 515 may include two or more different devices, such as a keyboard and a touch panel.

The output device 520 may be designed to output visual, audible, and/or haptic signals. The output device 520 may include an electronically controllable display or display device capable of outputting visual data to a user. For example, the output device 520 may include, but is not limited to, an LCD display, an LED display, an OLED display, a projector, or similar display device capable of outputting images, text, or the like to a user. As another, non-limiting, example, the output device 520 may include a wearable display separate from, but communicatively coupled to, the rest of the network node 500, such as a smart watch, smart glasses, a heads-up display, or the like. Further, the output device 520 may be a component of a smart phone, a personal digital assistant, a television, a table computer, a notebook (laptop) computer, a personal computer, a vehicle dashboard, or the like.

The output device 520 may include one or more speakers for producing sound. For example, the output device 520 may produce an audible alert or notification (e.g., a beep or chime). The output device 520 may include one or more haptic devices for producing vibrations, motion, or other haptic feedback. All, or portions, of the output device 520 may be integrated with the input device 515. For example, the input device 515 and output device 520 may form a touchscreen or similar touch-sensitive display. The output device 520 may be located near the input device 515.

The transceiver 525 includes at least one transmitter 530 and at least one receiver 535. The one or more transmitters 530 may be used to communicate with the UE 400, as described herein. Similarly, the one or more receivers 535 may be used to communicate with network functions in the PLMN and/or RAN, as described herein. Although only one transmitter 530 and one receiver 535 are illustrated, the network node 500 may have any suitable number of transmitters 530 and receivers 535. Further, the transmitter(s) 530 and the receiver(s) 535 may be any suitable type of transmitters and receivers.

In an embodiment, a method for implementing the present invention is provided as follows.

An Energy Analytics capability is activated at, or by, the EDAS. The activation can be based on:

Subscription to, or a request from, a 3rd party application (e.g. the EAS, VAL server) at a given DN area (or sub-area e.g. a hotspot area) and time (e.g. for a specific event).

Subscription to, or a request from, one or more wireless communication network operators (e.g. from OAM functions of one or more MNOs) or from an NF at a given DN area (or sub-area, e.g. a hotspot area) and time (e.g. for a specific event).

An Edge/cloud platform internal configuration (e.g. from the DN provider), if the DN load, or energy levels (from COTS hardware), or the UPF load (as captured at the N6 endpoint at the DN side), or the number of edge API invocations reach a pre-defined threshold. For example, the pre-defined threshold may be whether the DN load is greater than a specified percentage, at which threshold the Energy Analytics capability may be activated. The DN load may be defined, in this embodiment, as the load of computational resources and/or of the DN or platform services.

Pre-configuration from the OAM (e.g., if the EDAS is deployed by a MNO at the OAM or at the telco DN), if the DN load or energy levels (from COTS hardware) or the number of edge API invocations reach a pre-defined threshold. For example, the pre-defined threshold may be whether the DN load is greater than a specified percentage, at which threshold the Energy Analytics capability may be activated.

Per-slice activation of the Energy Analytics capability, in which case the EDAS provides the DN analytics for energy to be consumed only for a slice subset of computational resources.

Subscription to, or a request for, per-DNAI Energy Analytics, in which case the EDAS provides the analytics when the EDN server is accessed via a specific DNAI from the mobile core network.

Subscription to, or a request for, per-DNN Energy Analytics, in which case, for each DNN in a slice, the EDAS provides Energy Analytics.

In this embodiment, the EDAS, based on the activation of the capability, translates the area of interest, e.g. the DN service area (or sub-area, based on the activation), to a topological service area (i.e. a list of cells) within the area of interest.

In this embodiment, the EDAS requests the expected or predicted network usage data or energy level data for the target cells, from one or more of the following entities:

The OAM, in which case the requested data may include energy usage information per cell or per slice or, more generally, per-managed element.

The 5GC or NWDAF, in which case the requested data may include one or more of: slice demand/load analytics for the target list of cells; UPF/DNAI load or resource usage or DNN load resources or per-network slice resources; or DN performance analytics for the given list of cells.

The application server, in which case the requested data may include one or both of: EAS/VAL server load measurements; or EAS/VAL server traffic schedules for traffic to be delivered via 5GS.

From the edge/cloud platform, e.g. via the COTS hardware or the NFVI layer of the edge/cloud platform. Different implementations may envisage the data being received by different entities. In telco cloud environments (in an ICT domain), the energy measurement for the ICT equipment may be supported by a Remote Management Server (RMS), thereby to provide energy metering from a 3rd party perspective and energy data analysis services which include various reports, database management, and potential correlation services to understand the power consumption structure and optimization possibilities and progress (see ETSI ES 202 336-12 V1.2.1, ETSI ES 202 336-1).

In this embodiment, the EDAS receives the requested data described above (i.e. expected energy or usage/load data) and translates the data to energy data (using a predefined formula for quantifying the energy from the usage/load data, e.g. based on the energy, in Joules, per quantum of information (e.g., bit, packet or computational resource). Then the transformed parameters are stored at the EDAS to be used as input for the analytics.

In this embodiment, the EDAS provides Energy Analytics based on the data as received above. The analytics may be based, for example, on performing regression mechanisms to derive a distribution of energy consumption or using ML methods (and/or using historical data samples for the given area and time). Such Energy Analytics may be in form of:

Energy Sustainability Analytics, which may be defined as analytics relating to an expected time for which the DNN/DNAI energy consumption is sustainable under a certain load expectation for the target area of interest.

DNN/DNAI energy consumption/efficiency statistics for the target area of interest.

A DNN/DNAI energy consumption/efficiency predictions, with a given confidence level, for the target area of interest and a future time window (if requested).

In this embodiment, the EDAS may, based on the DN-related Energy usage/efficiency Analytics, proactively trigger actions to ensure that the edge energy efficiency is maintained at a sustainable level. Such triggered actions may include, for example, load balancing with other DNs (e.g. other edge platforms) to perform migration/relocation of EAS/VAL servers or instantiations of new EAS/VAL server instances at other candidate DNs. In this case, the EDAS interacts with the EES (or acts as the EES) and may also interact with other EESs for migration support while ensuring service continuity.

In this embodiment, the EDAS may send the Energy Analytics (i.e. the DN-related Energy usage/efficiency Analytics) to the consumer/subscriber.

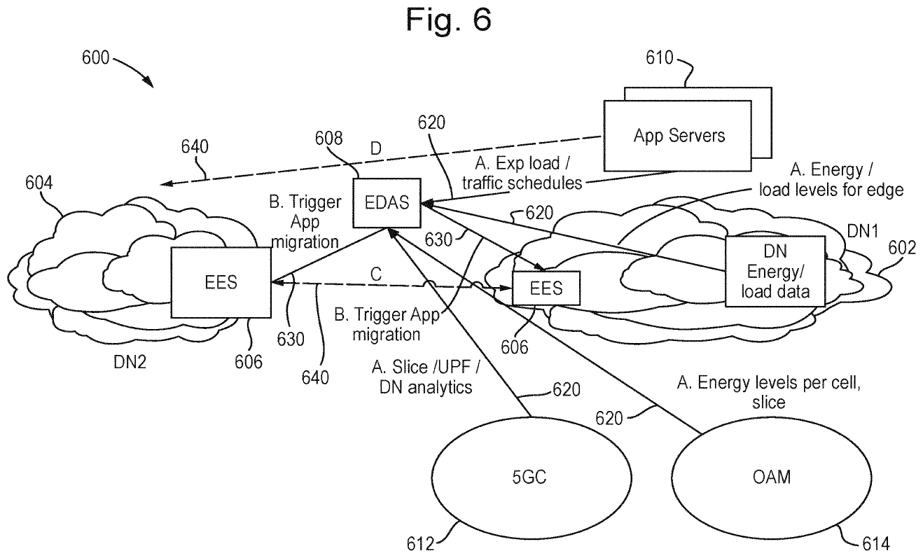

Exemplary elements of the above-described method are illustrated in, and further described below with reference to, FIG. 6.

FIG. 6 is a schematic illustration of an architecture 600 for implementing of a method for Application Server migration. In particular, the architecture 600 (which is an EDGEAPP case) comprises a first DN 602 and a second DN 604 which each deploy a respective EES 606. The EDAS 608 may be within the first DN 602 or the second DN 604, or in another DN altogether (e.g. a DN which coordinates one or both of the first and second DNs 602, 604).

FIG. 6 depicts the case in which the consumer is the EES 606 and the analytics trigger one or more Application Server 610 relocations.

In the depiction of FIG. 6 and the following description thereof, some of the features of the method described in the above embodiment are summarized (with particular focus on signaling) as follows.

The EDAS 608 collects data from the Application Servers 610, and/or the 5GC 612, and/or the OAM 614, and/or the first DN 602, and/or the second DN 604. The collection of data is indicated in FIG. 6 with single-headed arrows and the reference numeral 620.

The EDAS 608 performs Energy Analytics (i.e. the DN-related Energy usage/efficiency Analytics) and, based on or using the analytics output, it triggers Application Server 610 migration (e.g. the migration of one or more Application Servers 610 of the first DN 602 from the first DN 602 to the second DN 604). This trigger signal may be provided to the EES 606 of the first DN 602 or the second DN 604, or directly to the Application Servers 610 involved (or, in the case of EAS this can also be provided to a global Application Server of the same ASP). The triggering of Application Server migration is indicated in FIG. 6 by single-headed arrows and the reference numeral 630.

The migration of one or more Application Servers 610 is indicated in FIG. 6 by single-headed arrows and the reference numeral 640. These procedures are outlined in detail in TS 23.558.

The following embodiments aim to capture implementations for both derivation of edge energy analytics at the ADAES for triggering of the Application Context Relocation (ACR) or migration of the EAS, and derivation of edge energy analytics at the NWDAF.

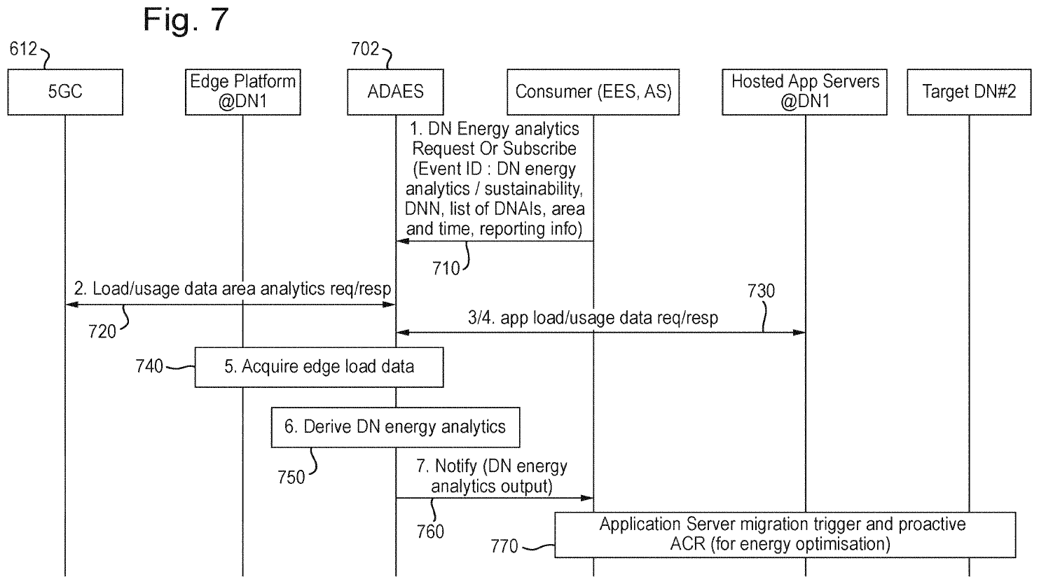

A first of these embodiments is depicted in FIG. 7, which is a schematic illustration of an implementation of derivation of DN Energy Analytics based on load/resource usage.

In this embodiment, the DN Energy Analytics are performed per DNN/DNAI, and may be used to trigger the Application Server migration to different cloud, in accordance with the triggering 630 and migration 640 described above with reference to FIG. 6.

In this embodiment, the Energy Analytics are based on NWDAF analytics and UPF/DN measurements of user plane load, as well as edge/application-side measurements of energy consumption.

In this embodiment, the Consumer (e.g. one or more of the Application Servers 610, the EESs 606, and/or the EAS) requests that the ADAES 702 perform Energy Analytics on the DN energy consumption/efficiency for one or more DNs/EDNs, whose Event ID may be “DN energy analytics”, e.g. the first DN 602 and/or the second DN 604, for a given DN service area (or sub-area) and a given time window. The requesting that the ADAES 702 perform Energy Analytics is indicated in FIG. 7 by a single-headed arrow and the reference numeral 710.

In this embodiment, the ADAES 702 subsequently authorizes the request and initiates a collection of network/slice usage data from the underlying wireless communications system (i.e. one or more MNO networks in the 5GC 612), in particular for the corresponding UPFs/DNAIs. Such data can be one or more of the following:

A traffic usage report from the UPF, which report may be per-DNAI, per-DNN, per S-NSSAI, or per-DNN/S-NSSAI.

A report of user plane traffic in the UPF for the accumulated usage of network resources (see TS 29.244).

A traffic usage report from the N6 endpoint at the respective DN.

A report of user plane traffic, per DNAI, for the accumulated usage of network resources.

UPF load analytics from the NWDAF (see TS 23.288), including UPF resource usage and load statistics or predictions.

Energy data from the OAM 612.

DN performance analytics from the NWDAF (see TS 23.288), and in particular the per-DNAI performance statistics or predictions for the target DNAIs.

Network slice load analytics from the NWDAF (see TS 23.288), and in particular statistics or predictions of the resource usage and load level per slice/Network Slice Instance (NSI).

The authorization by the ADAES 702 of the analytics request and subsequent collection of network/slice usage data from the underlying wireless communications system is indicated in FIG. 7 by a double-headed arrow and the reference numeral 720.

In this embodiment, the ADAES 702 may also request expected application service load and traffic schedules for ongoing or future sessions within the area from the EAS/VAL servers hosted at the target DN. Such data may also be obtained without sending a request if the ADAES 702 is co-located with the Vertical Application Layer (VAL) servers, in which case the data delivery is carried out via the enablement layer (e.g. SEAL Data Delivery (SEALDD) service).

The ADAES 702 receives, from the EAS/VAL servers hosted at the target DN, expected application service load and traffic schedules as requested. Such data may include:
A traffic schedule report for one or more of the Application Servers 610 (e.g. accumulated usage of schedules for all applications provided by the Application Server(s) at a given area).
An application traffic usage or load report per Application Server 610 or per Application Service.

The requesting and/or obtaining by the ADAES 702 of the expected application service load and traffic schedules for ongoing or future sessions within the area is indicated in FIG. 7 by a double-headed arrow and the reference numeral 730.

In this embodiment, the ADAES 702 may also obtain edge load/usage data internal to the edge platform (e.g. present at an edge database). The manner in which this data is obtained is dependent upon the implementation. In this embodiment, the data includes measurements or statistics of the load of computational resources and monitoring of the edge load/usage data internal to the edge platform energy consumed at the edge platform. The obtaining by the ADAES 702 of the edge load/usage data internal is indicated in FIG. 7 by the reference numeral 740.

In this embodiment, the ADAES 702, after receiving load/usage data and energy consumption data for one or more DNs/EDNs, prepares the data and performs Energy Analytics.

In particular, the ADAES 702 may first process the 5GS-provided usage/load analytics (in accordance with procedure 720), which are mapped as per-DNAI resource usage/load analytics and subsequently transformed into energy consumption analytics per DNAI (per-DNAI resource usage/load analytics, divided by the power consumption for the DN computational resources). For such analytics, a confidence level may be defined as a confidence level provided by the NWDAF.

The ADAES 702 may then process the rest of the data (which may be periodically provided in accordance with procedures 720-740) and check whether, and by how much, the confidence level of the analytics may or should be improved. The processing the rest of the data may be performed as follows.

The 5GS-provided usage/load data (obtained in accordance with procedure 720) are mapped as per-DNAI resource usage/load data which are transformed into energy consumption data per DNAI (per-DNAI resource usage/load, divided by the power consumption for the DN computational resources).

Then, the ADAES 702 calculates the edge energy consumption data at the edge for supporting this data volume, based on the edge internal data.

The application server usage/load/traffic pattern data are translated by the ADAES 702 into expected energy consumption contribution data at the edge for supporting this application data volume.

The manner of evaluation as to whether, and by how much, the confidence level may or should be improved is dependent upon on the analytics method (e.g. as in the cases of ML model inference, on-line analytics, etc.).

The preparing of the data and performing of Energy Analytics by the ADAES 702 is indicated in FIG. 7 by the reference numeral 750.

Hence, the ADAES 702 performs Energy Analytics to derive the predicted energy consumption at the target area and time horizon. Such analytics may include statistics or predictions of the energy consumption and/or efficiency per DNAI. Possible analytics outputs are summarized in the following table.

| Information | Description |
|---|---|
| DNN | Identifies the data network name (e.g. “internet”) for which |
| | analytics information is provided. |
| > DNAI | Identifier of a user plane access to one or more DN(s) of the DN. |
| > Energy metrics | The predicted energy metrics. |
| >> Energy | The predicted energy consumption per DNAI based on network |
| Consumption | and edge resource usage. |
| >> Energy | The energy efficiency per DNAI based on network and edge |
| Efficiency | resource usage (given a certain optimal energy consumption metric, |
| | which can be pre-configured). |
| >> DN Data | The predicted data volume per DNAI. |
| Volume | |
| > Applicable Area | The area (topological or geographical or edge area) where the |
| | analytics apply). |
| > Applicable time | The time period that the analytics applies to. |
| period/horizon | |
| > Confidence level | Confidence of the prediction. |

In this embodiment, the ADAES 702 subsequently sends the data to the Consumer, as indicated in FIG. 7 by a single-headed arrow and the reference numeral 760.

The Consumer (e.g. an application layer entity) may use these analytics as input to proactively trigger, for example:
An Application Server 610 migration (e.g. in accordance with procedure 640 between the Application Server(s) 610 and the second DN 604) to a different edge cloud or an edge-native service migration to a centralized cloud as a way of reducing the energy consumption for the edge (if consumption is expected to be very high, i.e. more than a determined threshold).
An Application Server 610 offboarding and the instantiation of a new server at the target edge/centralized cloud, in order to minimize energy consumption of the edge platform (taking into account the system-wide energy efficiency).

In the case in which the EES 606 supports the migration procedure from a source DN to a target DN, the source EES 606 may be the trigger entity which interacts (e.g. in accordance with the procedure 640 between respective EESs 606) with a target EES 606, thereby to support the proactive application context relocation and ensure service continuity of the edge services. In such cases, the ACR request will include a possible “Cause” for migration, e.g. “High Energy Consumption”, and will provide to the EAS a recommendation for an alternative DN to which to connect.

The use of these analytics to proactively trigger Application Server 610 migration or energy optimization actions by the Consumer is indicated in FIG. 7 by the reference numeral 770.

Thus, an implementation for deriving DN Energy analytics based on load/resource usage in a wireless communications system is provided.

In a second of these embodiments, there is provided an architecture for the implementation of derivation of edge energy analytics at the NWDAF, e.g. for traffic steering influence

In this embodiment, the EDAS 608 is a new service in the NWDAF which produces the Energy Analytics service per DNN/DNAI, the Energy Analytics being for consumption by an NF (e.g., a SMF or PCF) to steer traffic from one UPF/DNAI/slice to another for the corresponding DN.

In this embodiment, an NF (e.g., the SMF or PCF) subscribes to the NWDAF to receive Energy Analytics for a DN/DNAI/slice or a DNN (the user plane access to a DN may be mapped, via one more user plane paths, to different DNAIs) under certain criteria and/or periodically. Such one or more criteria may include, for example, an energy consumption upper threshold being expected to be reached for a given DN service area. The service Consumer may be an NF (e.g. a SMF or PCF) or an AF, and shall indicate in the request or subscription one or more of: an Analytics ID which is or includes “DN or DNAI Energy Level”; Target of Analytics Reporting: one or more DNAIs of one or more DNs; a preferred level of accuracy of the analytics; reporting thresholds, which apply only for subscriptions and which indicate conditions to be reached for energy analytics individual outputs (e.g. energy consumption per DNAI, energy efficiency per DN, etc.) upon whose satisfaction notification is received from the NWDAF; or Analytics Filter Information, an example being shown in table below.

The following table presents possible Analytics Filter Information relating to the request to subscribe to DN/DNAI Energy Analytics.

| Information | Description |
|---|---|
| Application | The identification of the application(s) for which the |
| ID (0 . . . max) | analytics information is subscribed or requested. |
| S-NSSAI | Identifies the Network Slice for which analytics |
| | information is subscribed or requested. |
| NSI ID(s) | Identifies the Network Slice instance(s) for which |
| | analytics information is subscribed or requested. |
| Area of Interest | Identifies the Area (i.e. set of TAIs, or cell IDs or list |
| | of edge service areas), for which the analytics |
| | information is subscribed or requested. |
| UPF anchor | Identifies the UPF where a UE has an associated |
| identity | PDU session. |
| One or more | One or more allowed DNNs to access the |
| DNNs | application. |
| List of DNAIs | Identifier of one or more allowed user plane access |
| | to one or more DN(s) where applications are |
| | deployed as defined in TS 23.501. |
| Application | List of IP address(s)/FQDN(s) of the Application |
| Server | Server(s) that a UE, group of UEs, or ‘any UE’ has a |
| Address(es) | communication session with for which DN |
| | Performance Analytic information is requested. |
| Energy | The energy efficiency KPI for the applications |
| Efficiency KPI | subscribed for the analytics. |
| DN/DNAI Energy | The formula or model (can be also a trained ML |
| Efficiency | model) for generating the energy efficiency output |
| model/formula | per DN or per DNAI. |
| List of | List of analytics subsets that are requested such as: |
| analytics subsets | energy consumption per DNAI or for list |
| | of DNAIs |
| | energy consumption per DNN or for list of |
| | DNNs |
| | energy efficiency per DNAI or for list of |
| | DNAIs |
| | energy efficiency per DNN or for list of DNAIs. |

In this embodiment, the NWDAF acquires data/analytics about the corresponding UPFs load or resource usage, and, from the OAM 614, data/analytics on energy resource usage (per cell or slice).

The NWDAF also subscribes to one or more AFs to receive energy usage data/information for a DN area (AFs can be edge—or centrally located). Subscription to multiple AFs may correspond to receiving energy usage data/information for different AF service areas.

In this embodiment, the NWDAF subsequently receives, from the one or more Afs, energy usage information for the DN area. The energy usage data received from the one or more AFs may include, for example, one or more of the parameters listed in the table below.

| Information | Description |
|---|---|
| DNN or DNAI or | To identify the DN or the DNAI or list of DNAIs |
| List of DNAIs | for which the measurements apply. |
| > Area of | The area within the DN/DNAI area of coverage |
| measurements | where the measurements apply (in case of sub-areas |
| | e.g. for localized service areas). this can be a cell ID |
| | or a geographical area. |
| > Energy | Energy usage per DNAI or per DN in Joules or as |
| Usage Data | energy efficiency (bit/J) or energy consumption per |
| | information (e.g. bit or packet or message). this |
| | measurement can be in form of a % value of the |
| | energy based on a threshold or a qualitative |
| | indication (low, medium, high). |
| > Computation | The method for calculating the energy usage data |
| method | (e.g. from app servers or for platform internal |
| | operation). |
| >> Energy | Indication whether the energy usage deviates from a |
| Consumption | KPI target as a flag or by measuring the delta value. |
| Deviation | |
| flag or value | |
| >> Timestamp | A time stamp associated to the Energy Usage Data |
| | provided by the AF. |

In this embodiment, the NWDAF derives, based on the received energy usage data and the UPF resource usage, analytics on the energy consumption per DNAI or per DN.

In this embodiment, the NWDAF subsequently sends the derived analytics to the Consumer NF whose expected energy consumption for a given DNAI is high, along with analytics of the expected energy consumption of other DNAIs/DNNs for a given area. The following table outlines possible analytics content output from the NWDAF.

| Information | Description |
|---|---|
| Application ID | Identifies the application for which analytics information is |
| | provided. |
| S-NSSAI | Identifies the Network Slice for which analytics information is |
| | provided. |
| DNN | Identifies the data network name (e.g. “internet”) for which |
| | analytics information is provided. |
| > DNAI | Identifier of a user plane access to one or more DN(s) of the DN. |
| > Energy metrics | The predicted energy metrics. |
| >> Energy | The predicted energy consumption per DNAI based on network |
| Consumption | and edge resource usage |
| >> Energy | The energy efficiency per DNAI based on network and edge |
| Efficiency | resource usage (given a certain optimal energy consumption metric, |
| | which can be pre-configured) |
| >> DN Data | The predicted data volume per DNAI. |
| Volume | |
| > Applicable Area | The area (topological or geographical or edge area) where the |
| | analytics apply) |
| > Applicable time | The time period that the analytics applies to. |
| period/horizon | |
| > Confidence level | Confidence of the prediction. |

In this embodiment, if the Consumer is an NF, it may check for or evaluate applications whose energy consumption/efficiency is impacted and may decide on a new DNAI for each of the applications (from an allowable list of DNAIs for each of the applications) and update Policy and Charging Control (PCC) rules (a DNAI parameter) accordingly. In other words, a high energy consumption (or low efficiency) of the DN/DNAI will have impact on some applications (which are hosted at the DN and may use a certain DNAI), and for these applications a new DNAI may be decided.

In this embodiment, if the Consumer is a PCF, and if the PCF receives analytics from the NWDAF which indicate that energy usage is above a threshold for a specific slice, the PCF may send new RAT/Frequency Selection Priority (RFSP) policies to the UE 400, thereby to move the UE 400 to a different radio spectrum accessed via a different slice whose energy usage is below the threshold.

In this embodiment, if the Consumer is an AF, the AF may decide on a new DNAI for each of the impacted applications (from an allowable list of DNAIs for each of the applications) and trigger AF influence for traffic routing procedures.

Alternatively, if the consumer is an NF, it may decide to downgrade QoS for one or more applications accessing the target DNN/DNAI, thereby to reduce energy usage, since downgrading QoS may lead to a reduction in use of computation resources at the edge for supporting the edge services.

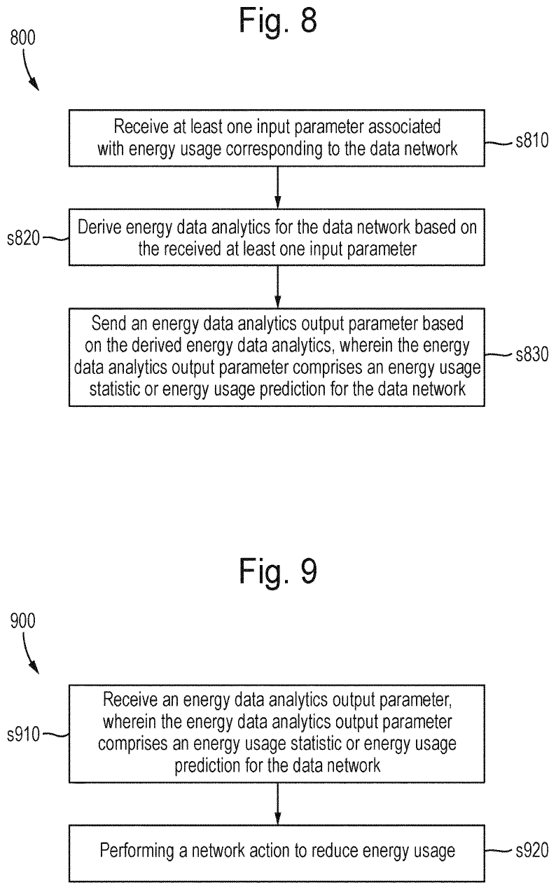

FIG. 8 is a process flow chart showing certain steps of a method 800 for providing energy data analytics for a DN of a wireless communication system.

In this embodiment, the method 800 includes, at step s810, receiving, e.g. by the ADAES 702, at least one input parameter associated with energy usage corresponding to the DN. In this embodiment, the receiving at least one input parameter associated with energy usage corresponding to the DN is performed in accordance with the collecting/receiving 720, 730, 740 of data as indicated in, and described above with reference to, FIG. 7.

At step s820, the method 800 includes deriving, e.g. by the ADAES 702, energy data analytics for the DN based on the received at least one input parameter. In this embodiment, the deriving energy data analytics for the DN based on the received at least one input parameter receiving at least one input parameter associated with energy usage corresponding to the DN is performed in accordance with the deriving 750 the DN Energy Analytics, as indicated in, and described above with reference to, FIG. 7.

At step s830, the method 800 includes sending, e.g. from the ADAES 702 to a Consumer, an energy data analytics output parameter based on the derived energy data analytics, wherein the energy data analytics output parameter comprises an energy usage statistic or energy usage prediction for the DN. In this embodiment, the sending an energy data analytics output parameter based on the derived energy data analytics is performed in accordance with the sending 760 the data to the Consumer, as indicated in, and described above with reference to, FIG. 7.

In this embodiment, the energy data analytics may be in accordance with the Energy Analytics described in embodiments above.

In this embodiment, the DN may be associated with one or more DNAIs, a DNN, a S-NSSAI, a NSI, one or more Application Servers, or a combination thereof.

In this embodiment, the derived energy data analytics and/or the energy data analytics output parameter may be for the one or more DNAIs.

In this embodiment, the method 800 may further comprise receiving, e.g. by the ADAES 702 from the Consumer, a request for energy data analytics for the DN. In this embodiment, the receiving a request for energy data analytics for the data network may be performed in accordance with the requesting 710 that the ADAES 702 perform Energy Analytics, as indicated in, and described above with reference to, FIG. 7.

In this embodiment, the request may be for energy analytics for one or more DNAIs associated with the DN, for an area of interest comprising the DN, or a combination thereof.

In this embodiment, the request for energy data analytics may be received from one or more of a network function, a management function, and an application function.

In this embodiment, the method 800 may further comprise identifying one or more DNAIs associated with the DN for which the energy data analytics apply, and mapping the energy data analytics output parameter to the one or more DNAIs. In this embodiment, the method 800 may further comprise generating energy data for the DN based on the received at least one input parameter, wherein the energy data is used as an input for deriving energy data analytics. The generating energy data for the DN based on the received at least one input parameter may be performed in accordance with the deriving 750 the DN Energy Analytics, as indicated in, and described above with reference to, FIG. 7.

In this embodiment, the method 800 may further comprise obtaining, e.g. by the ADAES 702, one or more application traffic parameters. Obtaining one or more application traffic parameters may comprise requesting one or more Application Servers to provide one or more application traffic parameters, and receiving from the one or more Application Servers one or more application traffic parameters based on the request.

In this embodiment, the at least one input parameter associated with energy usage may comprise at least one of the following: energy usage measurements for the DN; energy usage analytics for a managed element from an OAM; resource usage or load measurements from one or more UPFs; data analytics on UPF resource usage and/or load from a NWDAF or the OAM; energy usage measurements for a managed element from the OAM; energy or resource usage measurements associated with one or more UEs (e.g. in accordance with the UE 400) within the DN; resource usage measurements for one or more application enablement entities within the DN.

In this embodiment, the sending the energy data analytics output parameter at step s830 may trigger a single or group application migration to a different data network, e.g. in accordance with procedure 640, as indicated in, and described above with reference to, FIG. 6, and in accordance with migration 770, as indicated in, and described above with reference to, FIG. 7.

In this embodiment, the sending the energy data analytics output parameter at step s830 may trigger a DNAI change, a UPF change, a slice change, a network slice instance change, a network slice subnet instance change, an application QoS requirement change, a network QoS parameter change, or a combination thereof, for one or more applications using the DN.

In this embodiment, the at least one input parameter associated with energy usage may be an edge calculated measurement on the computational resource usage at or in the DN.

In this embodiment, the method 800 may be performed at an edge platform or a cloud platform.

Thus, a method 800 for providing energy data analytics for a DN of a wireless communication system is provided. The method 800 may be performed by the user equipment apparatus and/or network node of FIGS. 4 and 5.

FIG. 9 is a process flow chart showing certain steps of a method 900 for using energy data analytics for a DN of a wireless communication system.

In this embodiment, the method 900 includes, at step s910, receiving an energy data analytics output parameter, wherein the energy data analytics output parameter comprises an energy usage statistic or energy usage prediction for the DN. In this embodiment, the receiving an energy data analytics output parameter is performed in accordance with the Consumer receiving 760 analytics data from the ADAES 702, as indicated in, and described above with reference to, FIG. 7.

At step s920, the method includes performing, e.g. by the Consumer, a network action to reduce energy usage. In this embodiment, the performing a network action to reduce energy usage is performed in accordance with proactively triggering 770 Application Server migration or energy optimization actions, as indicated in, and described above with reference to, FIG. 7.

In this embodiment, the energy data analytics may be in accordance with the Energy Analytics described in embodiments above.

In this embodiment, the network action may comprise one or more of: a single or group application migration to a different DN; a DNAI change; a UPF change; a slice change; a network slice instance change; a network slice subnet instance change; an application QoS requirement change; a network QoS parameter change; or a combination thereof, for one or more applications using the DN.

In this embodiment, the method 900 may further comprise sending a request for energy data analytics for the DN. The sending a request for energy data analytics for the DN may be performed in accordance with the requesting 710 that the ADAES 702 perform Energy Analytics, as indicated in, and described above with reference to, FIG. 7.

In this embodiment, the request may be for energy data analytics for one or more DNAIs associated with the DN, for an area of interest comprising the DN, or a combination thereof.

In this embodiment, the method 900 may be performed by a NF or an AF.

Thus, a method 900 for using energy data analytics for a DN of a wireless communication system is provided. The method 900 may be performed by the user equipment apparatus and/or network node of FIGS. 4 and 5.

A solution provided by the methods and apparatuses described herein applies in the undesirable scenario in which one or more DNs are telco-/edge-deployed and the energy consumption for supporting DN services (e.g., for mobile data traffic as well as handling control/management functionalities) is expected to be a challenge, particularly due to limited computational resources per edge. In particular, a problem overcome is that of whether and how to use data analytics to predict the energy to be consumed at a DN network for supporting edge computing services, given expected or predicted traffic usage and network load.

Advantageously, methods and apparatuses of embodiments described herein tend to provide energy-efficient DN/DNAI operation, without sacrificing DN service performance.

Advantageously, the per-DN or per-DNAI analytics derived by the EDAS or ADAES of the embodiments described herein may be used by an AF to perform application server migration to different clouds, or by NF to trigger traffic steering to different DNs/DNAIs, or to perform another network action to minimize energy usage (e.g. a change of QoS or slice configurations).

The present inventors have realized that the existing technology does not address support for DN/DNAI energy analytics at the network side or edge side. At the platform side, energy usage information monitoring exists, and the embodiments described herein advantageously correlate the input from the network expected usage and the application traffic usage to derive an expectation on the energy cost at the DN side.

More advantageously still, such energy level predictions tend to allow the optimized dimensioning of applications to different DNs, thereby to ensure that energy KPIs are met whilst at the same time maintaining an acceptable level of performance.

It should be noted that the above-mentioned methods and apparatuses illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed methods and apparatuses may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatuses may be practiced in other specific forms. The described methods and apparatuses are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1-20. (canceled)

21. An apparatus for wireless communication, comprising:
at least one memory; and
at least one processor coupled with the at least one memory and configured to cause the apparatus to:
receive at least one input parameter associated with energy usage corresponding to a data network;
derive energy data analytics for the data network based at least in part on the received at least one input parameter; and
send an energy data analytics output parameter based on the derived energy data analytics, wherein the energy data analytics output parameter comprises an energy usage statistic or energy usage prediction for the data network.

22. The apparatus of claim 21, wherein the data network is associated with at least one of one or more data network access identifiers, a data network name (DNN), a single network slice selection assistance information (S-NSSAI), a network slice instance (NSI), or one or more application servers.

23. The apparatus of claim 22, wherein one or more of the derived energy data analytics or the energy data analytics output parameter are associated with the one or more data network access identifiers.

24. The apparatus of claim 21, wherein the at least one processor is configured to cause the apparatus to receive a request for energy data analytics for the data network.

25. The apparatus of claim 24, wherein the request is for energy data analytics for at least one of one or more data network access identifiers associated with the data network or an area of interest comprising the data network.

26. The apparatus of claim 24, wherein the request for energy data analytics is received from one or more of a network function, a management function, or an application function.

27. The apparatus of claim 21, wherein the at least one processor is configured to cause the apparatus to:
identify one or more data network access identifiers associated with the data network for which the energy data analytics apply; and
map the energy data analytics output parameter to the one or more data network access identifiers.

28. The apparatus of claim 21, wherein the at least one processor is configured to cause the apparatus to generate energy data for the data network based on the received at least one input parameter, wherein the energy data is used as an input for deriving energy data analytics.

29. The apparatus of claim 21, wherein the at least one processor is configured to cause the apparatus to:
obtain one or more application traffic parameters, including to:
request one or more application servers to provide one or more application traffic parameters; and
receive from the one or more application servers one or more application traffic parameters based on the request.

30. The apparatus of claim 21, wherein the at least one input parameter associated with energy usage comprises at least one of:
energy usage measurements for the data network;
energy usage analytics for a managed element from an operations, administration and management/maintenance (OAM);
resource usage or load measurements from one or more user plane functions (UPF);
data analytics on UPF resource usage and/or load from a network data analytics function (NWDAF) or the OAM;
energy usage measurements for a managed element from the OAM;
energy or resource usage measurements associated with one or more user equipment (UE) within the data network; or
resource usage measurements for one or more application enablement entities within the data network.

31. The apparatus of claim 21, wherein sending the energy data analytics output parameter triggers a single or group application migration to a different data network.

32. The apparatus of claim 21, wherein sending the energy data analytics output parameter triggers, for one or applications using the data network, one or more of a data network access identifier (DNAI) change, a user plane function (UPF) change, a slice change, a network slice instance change, a network slice subnet instance change, an application quality of service (QOS) requirement change, or a network QoS parameter change.

33. The apparatus of claim 21, wherein the at least one input parameter associated with energy usage is an edge calculated measurement on computational resource usage at the data network.

34. The apparatus of claim 21, wherein the apparatus is implemented at one or more of an edge platform or a cloud platform.

35. An apparatus for wireless communication, comprising:
at least one memory; and
at least one processor coupled with the at least one memory and configured to cause the apparatus to:
receive an energy data analytics output parameter, wherein the energy data analytics output parameter comprises an energy usage statistic or energy usage prediction for a data network; and
perform a network action to reduce energy usage.

36. The apparatus of claim 35, wherein the network action comprises one or more of:
a single or group application migration to a different data network; or
a data network access identifier (DNAI) change, a user plane function (UPF) change, a slice change, a network slice instance change, a network slice subnet instance change, an application quality of service (QOS) requirement change, a network QoS parameter change, or a combination thereof, for one or more applications using the data network.

37. The apparatus of claim 35, wherein the at least one processor is configured to cause the apparatus to send a request for energy data analytics for the data network.

38. The apparatus of claim 37, wherein the request is for energy data analytics for at least one of one or more data network access identifiers associated with the data network or an area of interest comprising the data network.

39. A processor for wireless communication, comprising:
at least one controller coupled with at least one memory and configured to cause the processor to:
receive at least one input parameter associated with energy usage corresponding to a data network;
derive energy data analytics for the data network based at least in part on the received at least one input parameter; and
send an energy data analytics output parameter based on the derived energy data analytics, wherein the energy data analytics output parameter comprises an energy usage statistic or energy usage prediction for the data network.

40. A processor for wireless communication, comprising:
at least one controller coupled with at least one memory and configured to cause the processor to:
receive an energy data analytics output parameter, wherein the energy data analytics output parameter comprises an energy usage statistic or energy usage prediction for a data network; and
perform a network action to reduce energy usage.
